(19) United States
(12) Patent Application Publication
(10) Pub. No.: US 2004/0010773 A1
(43) Pub. Date: Jan. 15, 2004

(54) Method and apparatus for displaying debug codes of a baisc input/output system

(75) Inventors: Yi-Hsin Chan, Taipei (TW); Ming-Hsiang Chou, Taipei (TW)

Correspondence Address: BRINKS HOFER GILSON & LIONE, NBC Tower, Suite 3600, 455 N. Cityfront Plaza Drive, Chicago, IL, 60611-5599, US

(73) Assignee: AKOM TECHNOLOGY CORPORATION.

(21) Appl. No.: 10/262,916

(22) Filed: Oct. 2, 2002

(30) Foreign Application Priority Data
Jul. 10, 2002 (TW) 091115313

(51) Int. Cl. G06F 9/44

(52) U.S. Cl. 717/104

(57) ABSTRACT

A method for displaying debug codes of a Basic Input/Output System includes the steps of: (a) receiving in sequence a plurality of the debug codes outputted by a host electronic apparatus during initialization of the host electronic apparatus; (b) storing the debug codes in sequence; and (c) in response to a select command input, displaying one of the debug codes stored in step (b). An apparatus implementing this method includes an input interface for receiving debug codes from a host electronic apparatus, a storage module including a plurality of memory components for storing the debug codes received by the input interface, a display unit for displaying one of the debug codes stored in the storage module, and a control unit for generating a select command input that is provided to the storage module to control output of one of the debug codes stored therein for showing on the display unit.

### CROSS-REFERENCE TO RELATED APPLICATION

This application claims priority of Taiwanese application no. 091115313, filed on Jul. 10, 2002.

### BACKGROUND OF THE INVENTION

1. Field of the Invention

The invention relates to a method and apparatus for displaying debug codes of a Basic Input/Output System, more particularly to a method and apparatus cooperating with a host electronic apparatus and capable of displaying debug codes of a Basic Input/Output System in several ways.

2. Description of the Related Art

Most modern-day electronic apparatus, such as motherboards, interface cards, etc., are provided with Basic Input/Output Systems (BIOS) for Power-On Self Tests (POST) and access of default set-up data upon initialization.

Due to the trend of computers toward multitasking operations, the operations associated with BIOS have grown in complexity. In the development stages of a computer system, even before an operating system is loaded, different factors, such as failure of some components, errors in BIOS codes, etc., may result in boot-up failure and hinder development progress. At this moment, due to the size limitation of BIOS codes, and because debug software cannot be executed since the operating system has yet to be loaded, the cause of failure can only be exhaustively sought through a vast source sea, or slowly sought with the aid of hardware-error detecting equipment. Therefore, as a solution to these problems, it has been proposed heretofore that when a certain stage of operation has proceeded through the control of the BIOS codes, a debug code corresponding to the operating stage should be sent out. In this way, a system developer can provide a peripheral device to be coupled to the system-under-test for debugging in order to intercept and display the debug codes in real time. A debug code received by the peripheral device is shown as long as a succeeding debug code has yet to be received. Hence, if a debug code is continuously shown by the peripheral device after a computer system is turned on and prior to loading of an operating system, a clue will be provided to the system developer as to the possible cause of system or peripheral failure so that appropriate remedy can be done to speed up the debugging procedure and thus the progress of system development. At present, this sort of simple debugging mechanism is widely used in the development of electronic apparatus, such as computers, motherboards, etc.

Current display apparatus used in displaying debug codes can be generally classified as plug-in types or built-in types. A plug-in type of display apparatus may be in the form of an interface card, such as a debug card, to be mounted on a socket of a host electronic apparatus, and can display debug codes directly thereon or through an external display device that receives the debug codes from the interface card.

On the other hand, a built-in type of display apparatus is built directly into a host electronic apparatus, such as a motherboard, such that the debug code corresponding to a failure in operation of the host electronic apparatus can be shown to the user by the built-in debug code display apparatus in real time.

Referring to FIG. 1, a conventional debug code display apparatus 12 is shown to be adapted for use with a host electronic apparatus for receiving and displaying a debug code during execution of BIOS 11 of the host electronic apparatus. The conventional debug code display apparatus 12 includes an input interface 121, a latch circuit 122, a decoder 123, and a seven-segment light emitting diode (LED) display component 124. Referring to FIG. 2, at step 13, when the host electronic apparatus is initialized, BIOS 11 will execute operations of POST, access of default set-up data, etc. Before each operation is executed, BIOS 11 will first send out a corresponding debug code to be received by the debug code display apparatus 12 at the input interface 121, and to be latched by the latch circuit 122 for temporary storage. Thereafter, at step 14, the decoder 123 converts the binary debug code latched by the latch circuit 122 into an appropriate format for driving the LED display component 124. Then, at step 15, the LED display component 124 receives the decoded output of the decoder 123 and displays the corresponding debug code in digit form so that the user is able to know the operation currently being executed under the control of BIOS 11. At step 16, the debug code display apparatus 12 detects whether a new debug code is received at the input interface 121. In the affirmative, indicative of a new operation being executed under the control of BIOS 11, the flow goes back to step 13, where the new debug code overwrites the previous debug code in the latch circuit 122, and then to steps 14 and 15 to display the new debug code on the LED display component 124. In the negative, the display operation ends. It is evident from the foregoing that the debug code display apparatus 12 displays the debug code corresponding to the operation currently being executed under the control of BIOS 11. Therefore, when an error occurs or the system hangs, the debug code displayed on the debug code display apparatus 12 can help the user locate the source of failure.

In practice, the cause of system error or failure may not be isolated to just a single operation, as it may often be attributed to one or more previous operations. Also, due to the increasing complexity of software and hardware configurations and operation of modern-day computers, execution of BIOS operations has changed from single-path to multi-path. That is, a current operation may be succeeded by one of many subsequent candidate operations, and the current operation may be also preceded by a number of candidate operations. Therefore, the display of a single debug code is often insufficient for inference of the associated preceding operation. In the aforesaid conventional debug code display apparatus 12, since the debug code of an associated preceding operation is overwritten by a current debug code when the latter is input into the latch circuit 122, information that is essential for proceeding with the debugging process is lost.

### SUMMARY OF THE INVENTION

Therefore, the object of the present invention is to provide a method and apparatus for displaying debug codes of a Basic Input/Output System that is capable of overcoming the aforesaid drawback associated with prior art.

According to one aspect of the present invention, there is provided a method for displaying debug codes of a Basic Input/Output System. The method includes the steps of:

(a) receiving in sequence a plurality of the debug codes outputted by a host electronic apparatus during initialization of the host electronic apparatus;

(b) storing the debug codes in sequence; and

(c) in response to a select command input, displaying one of the debug codes stored in step (b).

According to another aspect of the present invention, an apparatus for displaying debug codes of a Basic Input/Output System includes:

an input interface adapted to be connected electrically to a host electronic apparatus for receiving the debug codes outputted in sequence by the host electronic apparatus during initialization of the host electronic apparatus;

a storage module connected electrically to the input interface and including a plurality of memory components for storing the debug codes received by the input interface in sequence therein;

a display unit connected electrically to the storage module for displaying one of the debug codes stored in the storage module; and

a control unit connected electrically to the storage module and operable so as to generate a select command input that is provided to the storage module for controlling the storage module to output one of the debug codes stored therein for displaying on the display unit.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram showing a conventional debug code display apparatus;

FIG. 2 is a flowchart illustrating the operation of the debug code display apparatus of FIG. 1;

FIG. 3 is a schematic block diagram showing a host electronic apparatus that incorporates the preferred embodiment of an apparatus for displaying debug codes of a Basic Input/Output System according to this invention;

FIG. 4 is a schematic block diagram showing the preferred embodiment of an apparatus for displaying debug codes of a Basic Input/Output System according to this invention;

FIG. 5 is a schematic diagram showing a display device of a display unit of the preferred embodiment;

FIG. 6 is a flowchart illustrating how debug codes are stored in the preferred embodiment; and

FIG. 7 is a flowchart illustrating how the debug codes are selectively displayed in the preferred embodiment.

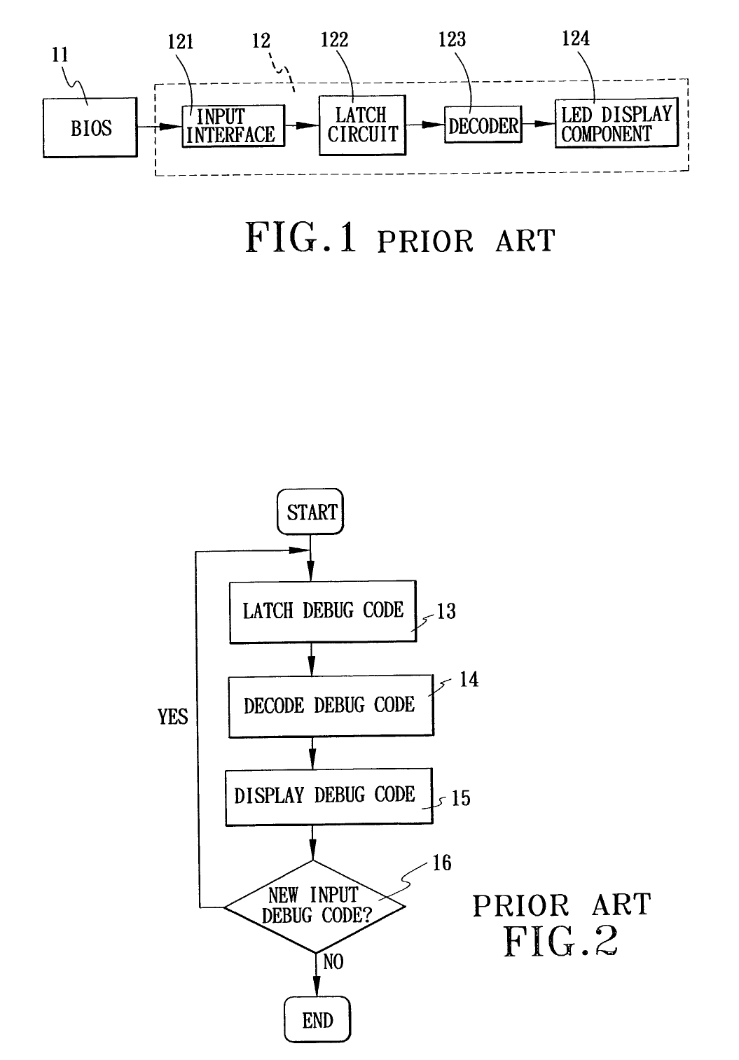

### DETAILED DESCRIPTION OF THE PREFERRED EMBODIMENT

The apparatus of this invention is adapted for use in a host electronic apparatus, such as a motherboard, interface card, etc. In the following description, the host electronic apparatus is a computer motherboard for illustrative purposes. The apparatus of this invention is used to display debug codes of a Basic Input/Output System (BIOS) that are outputted by the host electronic apparatus in sequence during initialization of the host electronic apparatus.

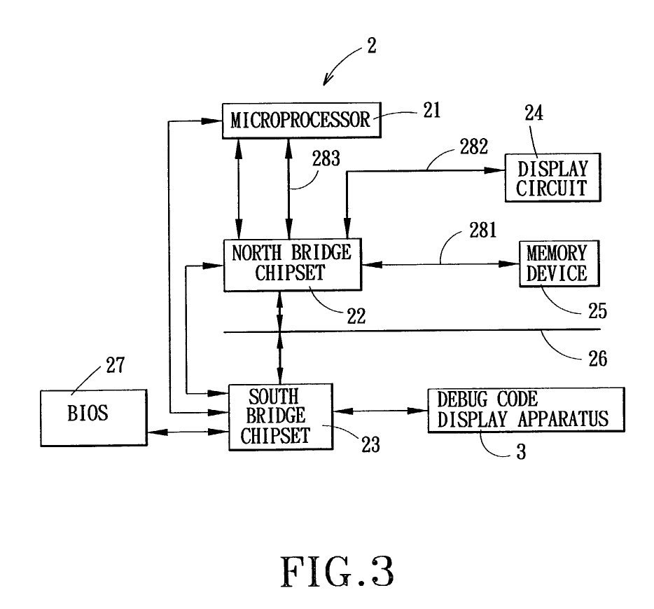

FIG. 3 is a schematic block diagram showing a motherboard 2 that incorporates the preferred embodiment of an apparatus 3 for displaying BIOS debug codes according to this invention. The motherboard 2 includes a microprocessor 21, a north bridge chipset 22, a south bridge chipset 23,a display circuit 24 (such as a display card or a display chipset), a memory device 25, a Peripheral Component Interconnect (PCI) bus 26, a BIOS 27, a memory bus 281, an Accelerated Graphics Port (AGP) bus 282, a front side bus (FSB) 283, and other expansion interface slots and data buses. The microprocessor 21 is the control center of the motherboard 2, and is in charge of most operating tasks, interrupt event handling, and data and signal processing. The north bridge chipset 22 is connected to the memory device 25 via the memory bus 281, to the display circuit 24 via the AGP bus 282, and to the microprocessor 21 via the front side bus (FSB) 283, and is responsible for communication among the memory device 25, the display circuit 24 and the microprocessor 21. The south bridge chipset 23 is responsible for operations of PCI peripheral devices, hard disk drives, floppy disk drives, computer mice, keyboards, etc., and is connected electrically to the debug code display apparatus 3 of this invention. The BIOS 27 has a plurality of program codes stored in a non-volatile memory, such as a read-only memory (ROM), a flash memory, etc. Each set of program codes is associated with a corresponding debug code such that when a computer that incorporates the motherboard 2 is initialized, the microprocessor 21 will load the program codes of the BIOS 27 via the south bridge chipset 23 for execution in sequence. Before each set of program codes is executed, the south bridge chipset 23 will send out the corresponding debug code to the debug code display apparatus 3 for reception by the latter.

In this embodiment, the debug code display apparatus 3 is connected electrically to the south bridge chipset 23 so as to receive the debug codes sequentially therefrom. In practice, the debug code display apparatus 3 is only required to be connected electrically to a transmission route of the debug codes, and does not need to be connected directly to the south bridge chipset 23. For example, it is feasible that the south bridge chipset 23 sends out the debug codes to the PCI bus 26. Under such a condition, the debug code display apparatus 3 may be connected to the PCI bus 26 for access to the debug codes.

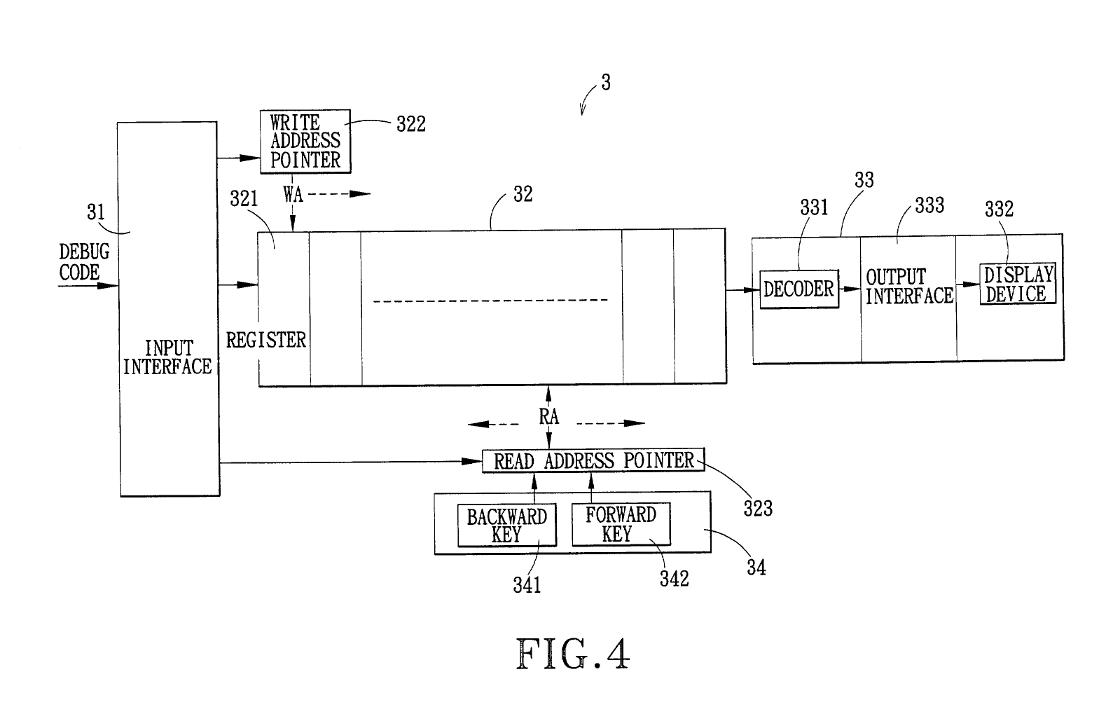

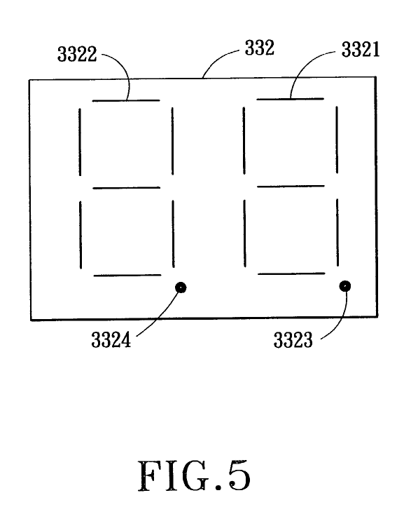

Referring to FIG. 4, the preferred embodiment of the debug code display apparatus 3 according to this invention is shown to include an input interface 31, a storage module 32, a display unit 33 and a control unit 34. The debug code display apparatus 3 operates in a data-writing mode when a debug code is inputted thereto, and is operable in a tracing mode when otherwise.

In this embodiment, the input interface 31 is connected electrically to the south bridge chipset 23 so as to receive debug codes sequentially therefrom. The input interface 31 is configured for electrical connection with the south bridge chipset 23 using any one of a number of known bus types of the motherboard 2, such as the Industry Standard Architecture (ISA) bus, the Low Pin Count (LPC) interface, the System Management Bus (SMB), the Universal Serial Bus (USB), the Peripheral Component Interconnect (PCI) Bus, etc.

The storage module 32 is connected electrically to the input interface 31, and includes a plurality of memory components 321, a write address pointer 322 and a read address pointer 323.

In this embodiment, each memory component 321 is a register. Since the bit length of a debug code is 8, the storage capacity unit of each memory component 321 is not smaller than 8 bits. The number of memory components 321 in the storage module 32 is thirty-two, and the memory components 321 are indexed in increments of 1, wherein the leftmost memory component 321 has an address of 0, and the rightmost memory component 321 has an address of 31.

The write address pointer 322 is connected electrically to the input interface 31 and the memory components 321, and is used to select one of the memory components 321 for writing and thus storing a debug code received at the input interface 31. In this embodiment, the write address pointer 322 sequentially and cyclically generates a Write Address (WA) in increments of 1 to index the memory components 321 within a range of 0 and 31. In other words, the write address pointer 322 generates the Write Address (WA) starting from an address value of 0 and increments the same by one unit until an address value of 31 is reached, during which time the address value is subsequently reset to 0 to complete one address generating cycle. The address incrementing action of the write address pointer 322 occurs only in the data-writing mode of the debug code display apparatus 3, i.e. presence of a feed-in operation of a debug code. For instance, when a first debug code is inputted, the Write Address (WA) generated by the write address pointer 322 is 0, and the debug code is stored in the memory component 321 indexed by the address value 0. Thereafter, when a second debug code is inputted, the Write Address (WA) generated by the write address pointer 322 is incremented to 1, and the debug code is stored in the memory component 321 indexed by the address value 1. In this way, when the thirty-second debug code is inputted, the Write Address (WA) generated by the write address pointer 322 is 31, and the debug code is stored in the memory component 321 indexed by the address value 31. Thereafter, when the thirty-third debug code is inputted, the Write Address (WA) generated by the write address pointer 322 will be reset to 0, and the debug code is stored once again in the memory component 321 indexed by the address value 0 and overwrites the first debug code. In this manner, a series of debug codes can be sequentially and cyclically stored in the memory components 321. The number of debug codes that can be stored in the display apparatus 3 of this invention is evidently much larger than that in the conventional debug code display apparatus 12 described beforehand since a number of the memory components 321 is utilized instead of the single latch circuit 122 employed in the conventional debug code display apparatus 12.

The read address pointer 323 is connected electrically to the input interface 31, the memory components 321 and the control unit 34, and is used to select one of the memory components 321 for outputting the debug code stored in the latter to the display unit 33. In this embodiment, when the display apparatus 3 operates in the data-writing mode, in order to allow the user to observe the latest debug code received at the input interface 31, the read address pointer 323 will update a Read Address (RA) generated thereby simultaneously with an address incrementing activity of the write address pointer 322. That is, the value of the Read Address (RA) generated by the read address pointer 323 will be equal to the Write Address (WA) generated by the write address pointer 322 such that the latest debug code can be outputted when the debug code display apparatus 3 operates in the data-writing mode. For instance, after the first debug code is stored in the memory component 321 indexed by the address value 0 due to operation of the write address pointer 322, the read address pointer 323 will generate the Read Address (RA) 0 to activate the memory component 321 indexed by the address value 0 so as to output the stored first debug code to the display unit 33. When the second debug code is stored in the memory component 321 indexed by the address value 1 due to operation of the write address pointer 322, the read address pointer 323 will generate the Read Address (RA) 1 to activate the memory component 321 indexed by the address value 1 so as to output the stored second debug code to the display unit 33. When the third debug code is stored in the memory component 321 indexed by the address value 2 due to operation of the write address pointer 322, the read address pointer 323 will generate the Read Address (RA) 2 to activate the memory component 321 indexed by the address value 2 so as to output the stored third debug code to the display unit 33. In this way, when the thirty-second debug code is stored in the memory component 321 indexed by the address value 31 due to operation of the write address pointer 322, the read address pointer 323 will generate the Read Address (RA) 31 to activate the memory component 321 indexed by the address value 31 so as to output the stored thirty-second debug code to the display unit 33. Similar to the Write Address (WA) from the write address pointer 322, the Read Address (RA) of the read address pointer 323 will be reset to 0 in the event of an address incrementing action after the maximum value (i.e., 31 in this embodiment) is reached. Thus, when the thirty-third debug code is stored in the memory component 321 indexed by the address value 0 due to operation of the write address pointer 322, the read address pointer 323 will also generate the Read Address (RA) 0 to activate the memory component 321 indexed by the address value 0 so as to output the stored thirty-third debug code to the display unit 33. It should be noted that, in this embodiment, the Read Address (RA) generated by the read address pointer 323 is determined by the write address (WA) when the debug code display apparatus 3 operates in the data-writing mode. However, when there is no feed-in of a debug code, and when a select command input is received by the read address pointer 323 from the control unit 34, the debug code display apparatus 3 will operate in the tracing mode, in which the Read Address (RA) will be generated by the read address pointer 323 with reference to the write address (WA) and the select command input from the control unit 34, and in which the read address pointer 323 will output a status signal (to be described later) to the display unit 33 to enable the user to trace the storing sequence of the displayed debug codes in the memory components 321.

The control unit 34 is used to provide the select command input to the read address pointer 323 to control incrementing or decrementing of the Read Address (RA). Thus, one of the debug codes stored in the memory components 321 can be selected for output to the display unit 33 so that the user can trace the execution of instructions in the BIOS 27 accordingly. Each time the control unit 34 generates the select command input, the read address pointer 323 will increment or decrement the Read Address (RA) cyclically. The select command input generated by the control unit 34 can be implemented by hardware or software, and includes at least a backward command for decrementing the Read Address (RA) cyclically, and a forward command for incrementing the Read Address (RA) cyclically. In this embodiment, as shown in FIG. 4, the control unit 34 includes a backward key 341 and a forward key 342, each of which is connected electrically to the read address pointer 323. The backward key 341 is operable so as to input the backward command, whereas the forward key 342 is operable so as to input the forward command.

It should be noted that several alternative implementations of the control unit 34 are available. For example, the backward and forward keys 341, 342 may be replaced with a contact switch such that the read address pointer 323 interprets the select command input according to a change in potential level upon activation of the contact switch. In another alternative, the backward and forward keys 341, 342 may be replaced with a single key that provides the functions of both keys. In this case, the read address pointer 323 will interpret the select command input according to the duration of a pressing action on the single key. For example, a shorter duration of key pressing can represent a forward command, while a longer duration of key pressing can represent a backward command, or vice versa. The read address pointer 323 may also be configured to interpret key pressing for a certain period of time as one of the backward and forward commands, and key pressing for a longer period of time as a toggle command for toggling between the backward and forward commands. In yet another alternative, one of the output port signals (e.g., Port 81) of the south bridge chipset 23 is reserved for generating the select command input, and the terminal that provides this output port signal is connected electrically to the read address pointer 323. A computer program is built into the south bridge chipset 23 and is executed in response to an input signal from an input accessory, such as a computer mouse, a keyboard, etc. In this way, the south bridge chipset 23 can be controlled to output the desired select command input for controlling the read address pointer 323. In a further alternative, a computer program is built into any of the components, such as the BIOS 27, the microprocessor 21, etc., of the motherboard 2. In response to an input signal from an input accessory, the computer program will be executed so that a control code can be provided to the read address pointer 323 via the input interface 31 or another control port or bus and that is to be used as the select command input. In view of the foregoing, it is apparent that the control unit 34 may generate the select command input to the read address pointer 323 by hardware, software or a combination of hardware and software. The read address pointer 323 can interpret the select command input through the duration of the select command input from the control unit 34, the change in potential level of the select command input, the change in frequency of the select command input, the change in phase of the select command input, the coded content of the select command input, or other methods not disclosed herein.

As mentioned hereinabove, the read address pointer 323 further provides a status signal to the display unit 33 so that the relationship between a current Read Address (RA) and a current Write Address (WA) can be shown to the user. In this way, the user can be informed of the storing sequence of the displayed debug codes in the memory components 321. In this embodiment, there are four types of status signals provided by the read address pointer 323. The first status signal is generated when the read address pointer 323 receives a forward command input for incrementing the Read Address (RA). The second status signal is generated when the read address pointer 323 receives a backward command input for decrementing the Read Address (RA). In order to avoid a situation where, after generating a plurality select command inputs, it becomes difficult to tell whether a currently displayed debug code is the latest one outputted by the BIOS 27 due to end of execution or failure, the read address pointer 323 is further configured to generate third and fourth status signals. The third status signal is generated by the read address pointer 323 when the currently displayed debug code is the foremost or earliest one in the storing sequence of the debug codes in the memory components 321, i.e., Read Address (RA) is equal to Write Address (WA)+1. The fourth status signal is generated by the read address pointer 323 when the currently displayed debug code is the latest one in the storing sequence of the debug codes in the memory components 321, i.e., Read Address (RA) is equal to Write Address (WA). In this embodiment, the states of two bits, e.g. 00, 01, 10 and 11, are used to represent the four status signals from the read address pointer 323, respectively. By displaying the status signal from the read address pointer 323, the user can be informed of the storing sequence of the displayed debug codes in the memory components 321.

It should be noted that, although four types of the status signal are generated by the read address pointer 323 in this embodiment, the actual number of the types of the status signal may be adjusted depending upon the actual requirements.

The display unit 33 displays the status signal received from the read address pointer 323 and the debug code received from the storage module 32 for viewing by the user. In this embodiment, the display unit 33 includes a display device 332 and an output interface 333 that is connected to the display device 332 and that provides electrical signals to drive the display device 332. The display device 332 can be a liquid crystal display, a light emitting diode (LED) array, an N-segment LED display component, etc. In this embodiment, the display device 332 consists of light emitting diodes. As shown in FIG. 5, the display device 332 of this embodiment includes a pair of seven-segment LED display components 3321, 3322 for displaying a debug code, and a pair of light emitting diodes 3323, 3324 for displaying the status signal from the read address pointer 323. The light emitting diode 3323 is turned on when the first or right bit of the status signal is at a high logic state, whereas the light emitting diode 3324 is turned on when the second or left bit of the status signal is at a high logic state. The output interface 333 can provide various kinds of electrical signals adapted to requirements of different kinds of display devices 332, such as multi-scan timing control signals, transfer synchronization handshake signals, light emitting diode cathode or anode driving signals, etc. In this embodiment, since the signals required for driving the seven-segment LED display components 3321, 3322 are not BCD-encoded signals, the display unit 33 further includes a decoder 331 that interconnects the output interface 333 and the storage module 32 and that converts the BCD digital debug code into a seven-segment LED display format suitable for the display device 332. It should be noted that the signal format conversion performed by the decoder 331 actually depends on the signal format required by the display device 332, which may require an ASCII or dot-matrix format. Therefore, if the signal formats between the display device 332 and the output of the storage module 32 are identical, the decoder 331 may be eliminated. For example, if the display device 332 is a liquid crystal display that accepts BCD-encoded signals, the decoder 331 will not be required.

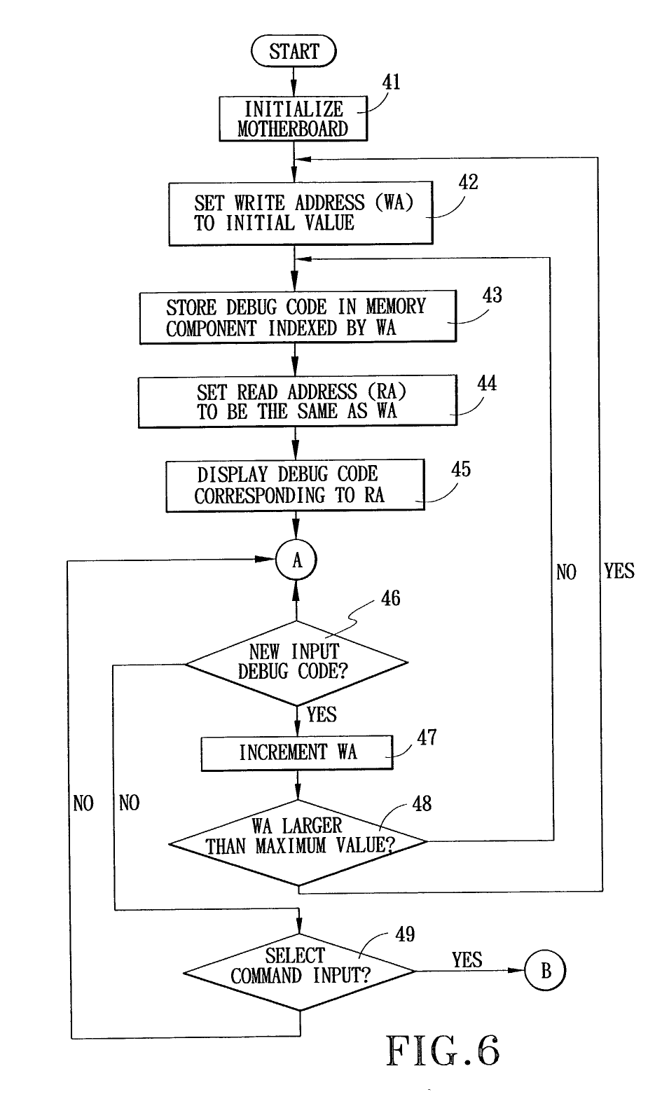

For a more detailed description of the operating relationship among the aforesaid components, reference is made to FIG. 6, which shows a flowchart to illustrate operation of the preferred embodiment in the data-writing mode.

At step 41, when the motherboard 2 is initialized, BIOS 27 will be loaded to execute operations of POST and access of default set-up data, etc. Before each operation is executed, BIOS 27 will first send out the associated debug code to the display apparatus 3.

At step 42, when a first debug code is received via the input interface 31, the write address pointer 322 sets the Write Address (WA) to its initial value of 0, and the memory component 321 indexed by the address value 0 is activated. The flow then proceeds to step 43.

At step 43, the debug code at the input interface 31 is stored in the activated memory component 321 indexed by the Write Address (WA) from the write address pointer 322. The flow then proceeds to step 44.

At step 44, since the display apparatus 3 currently operates in the data-writing mode, the Read Address (RA) generated by the read address pointer 323 is set to be the same as the Write Address (WA), and the memory component 321 indexed by the Read Address (RA) is activated such that the latest debug code received at the input interface 31 is outputted to the display unit 33. The flow then proceeds to step 45.

At step 45, the decoder 331 converts the digital signal of the debug code into a seven-segment LED display format, which is subsequently provided to the display device 332 via the output interface 333. At this time, the seven-segment LED display components 3321, 3322 are driven to display the debug code so as to allow the user to observe the operation currently being executed under the control of BIOS 27.

Thereafter, at step 46, the write address pointer 322 detects whether the input interface 31 received a new debug code. In the affirmative, the flow goes to step 47. Otherwise, the flow goes to step 49.

At step 47, the write address pointer 322 will increment the Write Address (WA) so as to index a succeeding memory component 321. The flow then proceeds to step 48.

At step 48, the write address pointer 322 will determine whether the current Write Address (WA) is larger than the maximum value (e.g., 31 in this embodiment). In the affirmative, the flow goes back to step 42 to reset the Write Address (WA) to 0. Otherwise, the flow goes back to step 43. In this way, the debug codes can be written sequentially and cyclically into the memory components 321, and the latest debug code received by the input interface 31 can be shown on the display device 332.

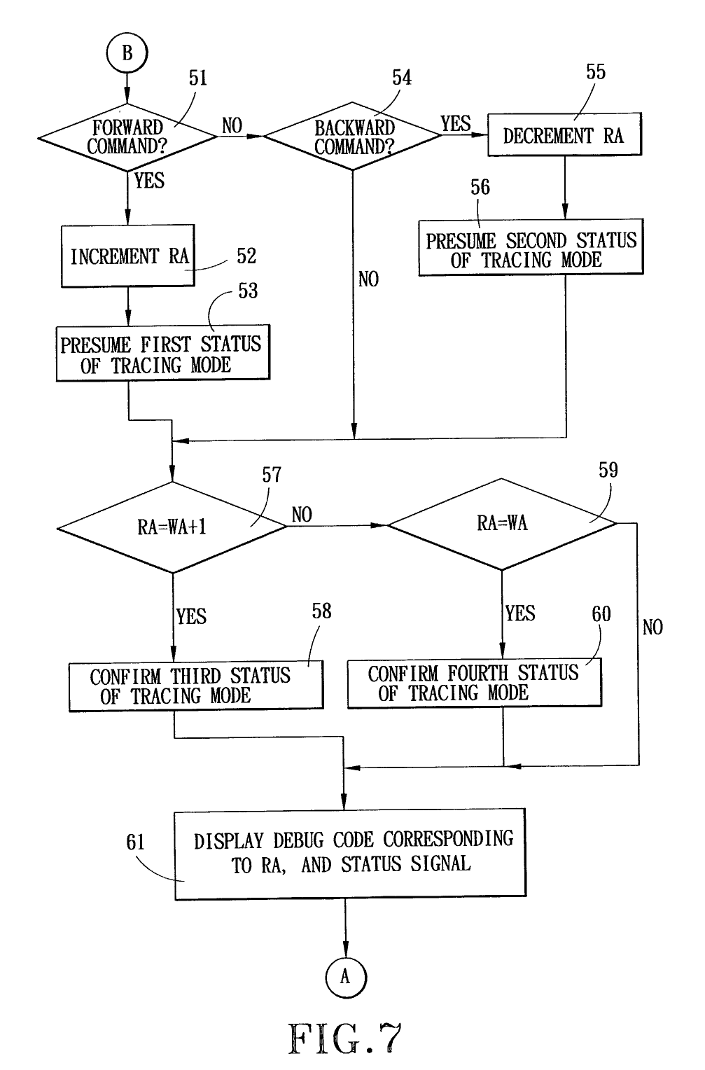

When there is no new debug code from the input interface 31 detected, this could mean that the operations associated with the BIOS 27 have been completed or that the BIOS operations were halted due to the presence of an error or failure. Therefore, at step 49, the read address pointer 323 will detect whether a select command input was received from the control unit 34. In the affirmative, this means that the user wishes to trace the execution path of the operations associated with the BIOS 27. The flow will then go to a tracing flow (B) (see FIG. 7). Otherwise, the flow goes back to step 46 to continue monitoring the input interface 31.

Reference is now made to FIG. 7, which shows a flowchart to illustrate operation of the preferred embodiment in the tracing mode. It should be noted that, during operation in the tracing mode, when the input interface 31 receives a new debug code, operation in the tracing mode must be interrupted, and the data-writing mode takes precedence so that the flow will jump back to step 46 of the data-writing mode (i.e., the node A in FIG. 6). Therefore, in the tracing mode, the flow permits the return to step 46 of the data-writing mode for detecting a new debug code.

At step 51 of the tracing mode, the read address pointer 323 determines whether a forward command was received from the control unit 34. In the affirmative, the flow goes to step 52. Otherwise, the flow goes to step 54.

At step 52, the read address pointer 323 increments the Read Address (RA) by one unit. It should be noted here that, if the current value of the Read Address (RA) is equal to the maximum value, the Read Address (RA) is reset to 0. The flow then goes to step 53.

At step 53, a first status of the tracing mode, i.e., the read address pointer 323 received a forward command for incrementing the Read Address (RA), is presumed. The flow then goes to step 57.

At step 54, the read address pointer 323 determines whether a backward command was received from the control unit 34. In the affirmative, the flow goes to step 55. Otherwise, the flow goes to step 57.

At step 55, the read address pointer 323 decrements the Read Address (RA) by one unit. It should be noted here that, if the current value of the Read Address (RA) is equal to the minimum value of 0, the Read Address (RA) is reset to the maximum value of 31. The flow then goes to step 56.

At step 56, a second status of the tracing mode, i.e., the read address pointer 323 received a backward command for decrementing the Read Address (RA), is presumed. The flow then goes to step 57.

At step 57, the read address pointer 323 determines whether the debug code associated with the updated Read Address (RA) is the foremost or earliest one in the storing sequence of the debug codes in the memory components 321 (i.e., RA=WA+1). In the affirmative, the flow goes to step 58. Otherwise, the flow goes to step 59.

At step 58, a third status of the tracing mode, i.e., the currently displayed debug code is the foremost or earliest one in the storing sequence of the debug codes in the memory components 321, is confirmed. The flow then goes to step 61.

At step 59, the read address pointer 323 determines whether the debug code associated with the updated Read Address (RA) is the latest one in the storing sequence of the debug codes in the memory components 321 (i.e., RA=WA). In the affirmative, the flow goes to step 60. Otherwise, the flow goes to step 61.

At step 60, a fourth status of the tracing mode, i.e., the currently displayed debug code is the latest one in the storing sequence of the debug codes in the memory components 321, is confirmed. The flow then goes to step 61.

At step 61, the read address pointer 323 activates the memory component 321 indexed by the updated Read Address (RA) such that the debug code stored therein is outputted to and shown by the display unit 33. The read address pointer 323 further provides the appropriate status signal to the display unit 33 for viewing by the user. Finally, the flow will jump back to the node (A) in the data-writing mode (see FIG. 6) for detecting the receipt of a new debug code by the input interface 31.

It should be noted that, although the aforesaid tracing mode uses steps 51, 54, 57 and 59 for determining the tracing mode status, it is feasible for one skilled in the art to adjust the order or even integrate some of these steps in actual practice.

Therefore, through the select command input from the control unit 34, the display unit 33 is able to show the debug code stored in any of the memory components 321, and a status signal corresponding to the debug code to enable the user to observe and trace the execution path of operations associated with the BIOS 27. The number of debug codes available in the display apparatus 3 of this invention for debug tracing is sufficient for the user to infer the execution path of the BIOS operations accordingly. In summary, the debug code display apparatus 3 of this invention saves a lot of manpower and time in maintaining and developing a host electronic apparatus, such as motherboards and interface cards, by permitting selective display of debug codes that were received in sequence from the host electronic apparatus.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method for displaying debug codes of a Basic Input/Output System, comprising the steps of:
(a) receiving in sequence a plurality of the debug codes outputted by a host electronic apparatus during initialization of the host electronic apparatus;
(b) storing the debug codes in sequence; and
(c) in response to a select command input, displaying one of the debug codes stored in step (b).

2. The method as claimed in claim 1, further comprising, between steps (b) and (c), the step of displaying one of the debug codes immediately after storing said one of the debug codes.

3. The method as claimed in claim 1, wherein step (c) includes the sub-step of displaying a succeeding one of the debug codes stored in step (b) when the select command input is judged to be a forward command.

4. The method as claimed in claim 1, wherein step (c) includes the sub-step of displaying a preceding one of the debug codes stored in step (b) when the select command input is judged to be a backward command.

5. The method as claimed in claim 1, wherein information relevant to order of the displayed one of the debug codes in the storing sequence of step (b) is further displayed in step (c).

6. The method as claimed in claim 5, wherein the information is a first status signal when the select command input is judged to be a forward command.

7. The method as claimed in claim 5, wherein the information is a second status signal when the select command input is judged to be a backward command.

8. The method as claimed in claim 5, wherein the information is a third status signal when the displayed one of the debug codes is a foremost one in the storing sequence of step (b).

9. The method as claimed in claim 5, wherein the information is a fourth status signal when the displayed one of the debug codes is a latest one in the storing sequence of step (b).

10. An apparatus for displaying debug codes of a Basic Input/Output System, said apparatus being adapted for use with a host electronic apparatus so as to receive the debug codes outputted by the host electronic apparatus in sequence during initialization of the host electronic apparatus, said apparatus comprising:
an input interface adapted to be connected electrically to the host electronic apparatus for receiving the debug codes;
a storage module connected electrically to said input interface and including a plurality of memory components for storing the debug codes received by said input interface in sequence therein;
a display unit connected electrically to said storage module for displaying one of the debug codes stored in said storage module; and
a control unit connected electrically to said storage module and operable so as to generate a select command input that is provided to said storage module for controlling said storage module to output one of the debug codes stored therein for displaying on said display unit.

11. The apparatus of claim 10, wherein each of said memory components has a storage capacity not smaller than a bit length of any of the debug codes.

12. The apparatus of claim 11, wherein said storage module further includes a write address pointer connected electrically to said memory components and said input interface, said write address pointer generating a write address that is cyclically incremented when said input interface receives one of the debug codes, and activating one of said memory components indexed by the write address for storing said one of the debug codes received by said input interface.

13. The apparatus of claim 12, wherein said storage module further includes a read address pointer connected electrically to said memory components and said control unit, said read address pointer generating a read address in response to the select command input from said control unit, and activating one of said memory components indexed by the read address to output said one of the debug codes stored therein to said display unit.

14. The apparatus of claim 13, wherein said read address pointer is further connected electrically to said input interface, the read address generated by said read address pointer being the same as the write address whenever said input interface receives one of the debug codes such that a latest one of the debug codes received by said input interface can be displayed on said display unit.

15. The apparatus of claim 13, wherein said read address pointer further generates a status signal outputted to said display unit to indicate relationship between the read address and the write address.

16. The apparatus of claim 10, wherein said display unit includes a display device and an output interface interconnecting said display device and said storage module so as to control operation of said display device.

17. The apparatus of claim 16, wherein said display unit further includes a decoder interconnecting said output interface and said storage module, said decoder decoding the debug codes stored in said storage module to a suitable format required by said display device.

18. The apparatus of claim 13, wherein the select command input is a forward command for incrementing the read address from said read address pointer.

19. The apparatus of claim 13, wherein the select command input is a backward command for decrementing the read address from said read address pointer.

20. The apparatus of claim 13, wherein said control unit includes a component connected electrically to said read address pointer and operable so as to enable said control unit to generate the select command input.

21. The apparatus of claim 20, wherein said read address pointer interprets the select command input according to duration of the select command input.

22. The apparatus of claim 20, wherein said read address pointer interprets the select command input according to change in potential level of the select command input.

23. The apparatus of claim 20, wherein said read address pointer interprets the select command input according to change in frequency of the select command input.

24. The apparatus of claim 20, wherein said read address pointer interprets the select command input according to change in phase of the select command input.

25. The apparatus of claim 20, wherein said read address pointer interprets the select command input according to coded content of the select command input.

26. The apparatus of claim 20, wherein said component is a press key.

27. The apparatus of claim 20, wherein said component is a contact switch.

28. The apparatus of claim 13, wherein said control unit includes a computer program that is executed in response to an input signal from the host electronic apparatus so as to enable said control unit to generate the select command input.

29. The apparatus of claim 28, wherein the select command input is in the form of a control code.

30. The apparatus of claim 28, wherein the select command input is in the form of an output port signal from the host electronic apparatus.
